(19) United States
(12) Patent Application Publication
(10) Pub. No.: US 2013/0252198 A1
(43) Pub. Date: Sep. 26, 2013

(54) DENTAL CLIP

(71) Applicants: John Boos, Grand Haven, MI (US); Scott Doegnes, West Olive, MI (US); Heath O'Leary, Grand Haven, MI (US)

(72) Inventors: John Boos, Grand Haven, MI (US); Scott Doegnes, West Olive, MI (US); Heath O'Leary, Grand Haven, MI (US)

(21) Appl. No.: 13/793,830

(22) Filed: Mar. 11, 2013

Related U.S. Application Data
(60) Provisional application No. 61/609,108, filed on Mar. 9, 2012.

(51) Int. Cl. A61C 5/12; A61C 5/04

(52) U.S. Cl. CPC A61C 5/125; A61C 5/04
USPC 433/39; 433/226; 433/215

(57) ABSTRACT

A matrix band retainer clip for sealing a matrix band against a tooth is provided. The retainer clip includes a pair of tines, each of which has a generally wedge shaped piece with a pair of contact surfaces that are angled relative to one another. A spring is coupled with and extends between the tines and biases the tines towards one another to apply a biasing force from at least one contact surface of each tine against the matrix band thereby sealing the matrix band against the tooth. The spring has a generally U-shaped portion with a pair of vertically extending legs coupled with the tines at their lower ends and interconnected at their upper ends by a generally laterally extending leg for distributing a stress across a length of the spring in response to the tines being separated from one another.

### CROSS REFERENCE TO RELATED APPLICATION

This application claims the benefit of application Ser. No. 61/609,108 filed Mar. 9, 2012.

### BACKGROUND OF THE INVENTION

1. Field of the Invention

The present invention is related generally to matrix band retainer clips for biasing and sealing a sectional matrix band against a tooth.

2. Related Art

When filling a cavity that extends to an edge of a tooth, it is common to engage a matrix band against the tooth so that a liquid filling material may be injected into the cavity and cured to restore the tooth to approximately its natural state. Retainer clips are commonly employed to bias and seal the matrix band against the tooth to prevent the liquid filling material from leaking out of the cavity before it cures. Different types of retainer clips are available for sealing the matrix band against the tooth, but these retainer clips all have various shortcomings. For example, known retainer clips typically provide limited visibility, are limited to use on a small range of teeth, are hard to open during procedures, provide limited visibility of the tooth being worked on, and degrade after each use. Dentists typically carry a range of different retainer clips for use with different types of teeth and backups of each in case of failure. Also, many known retainer clips have a tendency of disengaging during the filling procedure, which requires a rework of the entire procedure.

There remains a continuing need for an improved retainer clip which may be manufactured at a low cost and has an increased life span.

### SUMMARY OF THE INVENTION

An aspect of the present invention provides for a matrix band retainer clip for sealing a matrix band against a tooth. The retainer clip includes a pair of tines, each of which has a generally wedge shaped piece with a pair of contact surfaces that are angled relative to one another. A spring is coupled with and extends between the tines and biases the tines towards one another to apply a biasing force from at least one contact surface of each tine against the matrix band thereby sealing the matrix band against the tooth. The spring has a generally U-shaped portion with a pair of vertically extending legs coupled with the tines at their lower ends and interconnected at their upper ends by a generally laterally extending leg for distributing a stress across a length of the spring in response to the tines being separated from one another.

Because of the unique shape of the spring, stresses from spreading the tines apart are distributed along substantially the entire length of the spring and there is no centralized stress point. As such, all deformation of the spring when spreading the tines is elastic, thus ensuring that the retainer clip always returns to substantially the same resting condition after each use. Because there is no plastic deformation, spreading the tines does not result in work hardening of the base material of the spring. This allows for a substantially improved lifespan as compared to other known matrix retainer clips, which tend to work harden and become increasingly brittle with each use.

When in an installed condition, the spring also biases the tines both towards one another and in a downward direction to prevent accidental detachment of the retainer clip from the matrix band. In other words, the connection between the retainer clip and the sectional matrix band is stronger and more durable than possible with other known retainer clips.

The retainer clip also provides improved visibility of the tooth being worked on for the dentist, requires less force to open and may be used on a wide range of different teeth on both sides of the mouth. As such, in addition to being easier to use than other known retainer clips, a dentist does not need to keep a large selection of clips for different types of teeth and backups for each.

### BRIEF DESCRIPTION OF THE DRAWINGS

These and other features and advantages of the present invention will be readily appreciated, as the same becomes better understood by reference to the following detailed description when considered in connection with the accompanying drawings wherein:

FIG. 1 is a perspective elevation view of a sectional matrix band disposed between a tooth with a cavity and an adjacent tooth;

FIG. 2 is a perspective elevation view of an exemplary embodiment of a matrix band retainer clip;

FIG. 3 is a top elevation view of the exemplary embodiment of the matrix band retainer clip;

FIG. 4 is a side elevation view of the exemplary embodiment of the matrix band retainer clip;

FIG. 5 is a perspective elevation view showing tines of the exemplary embodiment of the matrix band retainer clip being spread apart from one another by a set of forceps in engagement with apertures on the tines;

FIG. 6 is a perspective elevation view showing the tines of the exemplary embodiment of the matrix band retainer clip being spread apart from one another by a set of forceps in engagement with notches on the tines;

FIG. 7 is a perspective elevation view of the exemplary embodiment of the matrix band retainer clip in engagement with a matrix band and holding a rubber dam;

FIG. 8 is another perspective elevation view of the exemplary embodiment of the matrix band retainer clip in engagement with a matrix band and holding a rubber dam;

FIG. 9 is a fragmentary and side view showing the direction of the biasing force by the tine on the tooth and the matrix band; and

FIG. 10 is a side elevation view showing the exemplary embodiment of the matrix band retainer clip in engagement with a sectional matrix band.

### DESCRIPTION OF THE ENABLING EMBODIMENT

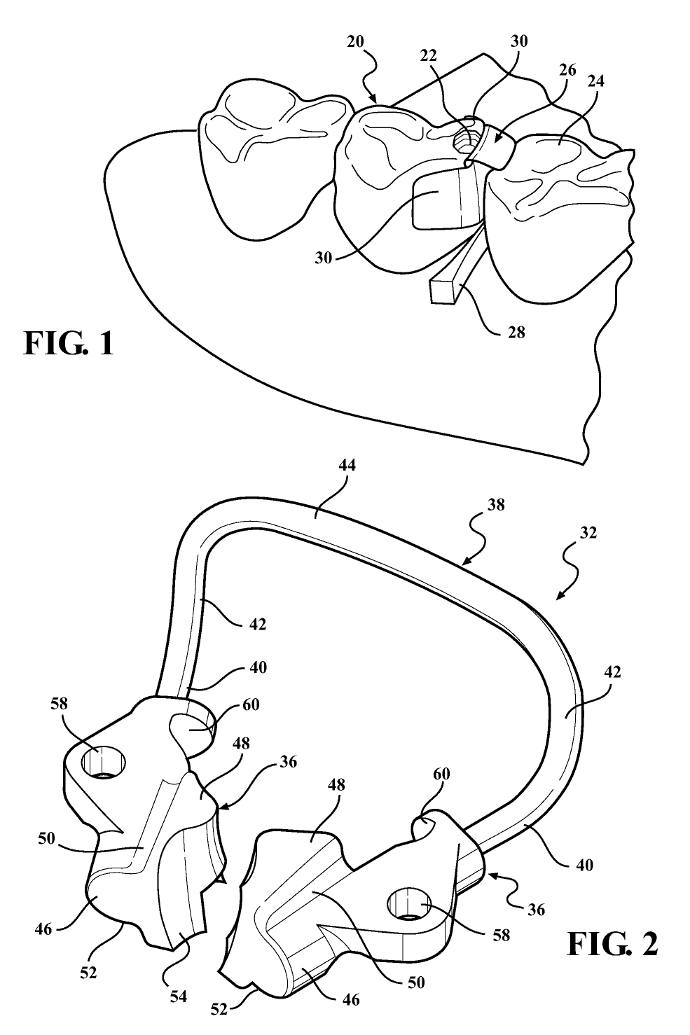

FIG. 1 shows a tooth 20 with a bored out cavity 22 for receiving a filling is shown. As shown, the bored out cavity 22 extends from a middle area of the tooth to an edge that faces an adjacent tooth 24. Although it should be appreciated that the tooth 20 to receive the filling does not necessarily have to be decayed to have a cavity that requires a filling (e.g. it could be cracked or chipped), it will hereinafter be referred to as the “decayed tooth 20”. A sectional matrix band 26 (typically of stainless steel, plastic, etc.) is inserted between the decayed tooth 20 and an adjacent tooth 24 for maintaining a liquid filling material in the cavity 22 while the filling material cures from the liquid state to a solid state. As shown, a lower portion of the sectional matrix band 26 is biased against the decayed tooth 20 by a wedge 28 which is inserted between the sectional matrix band 26 and the adjacent tooth 24 to bias the lower portion of the sectional matrix band 26 against the decayed tooth 20 and establish a seal therebetween. However, in this Figure, the sides, or wings 30, of the sectional matrix band 26 are not sealed against the decayed tooth 20. If these wings 30 remain unsealed when the filling material is injected into the bored cavity 22, then some of the liquid filling material may leak out of the cavity 22 before the curing is complete. This may result in a distorted outer surface on the restored tooth.

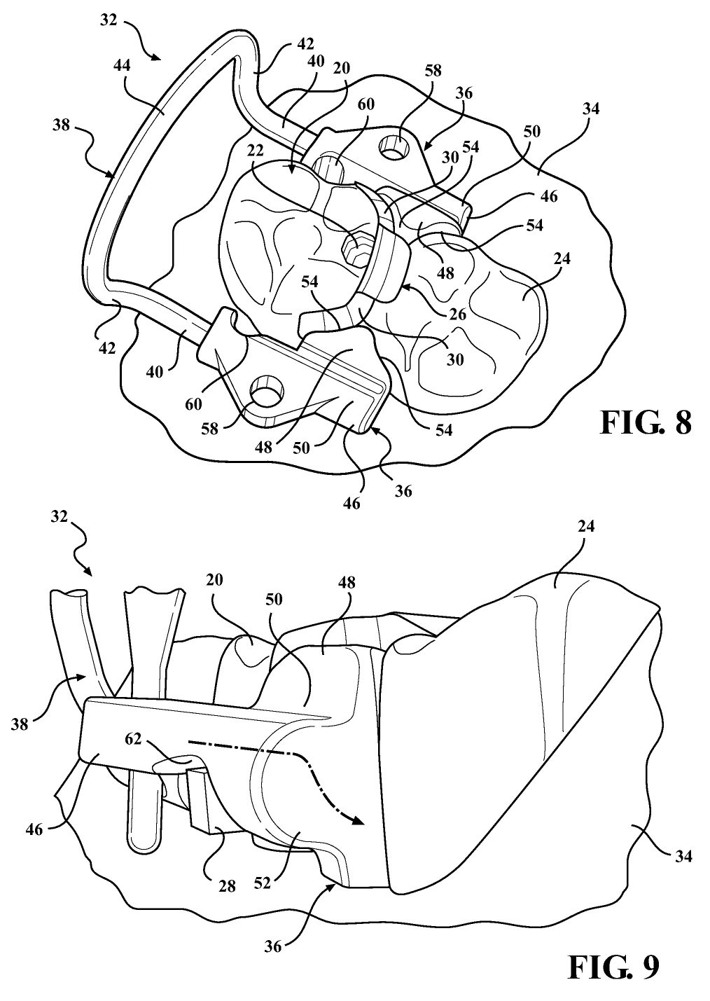

Referring to FIGS. 2-10, wherein like numerals indicate corresponding parts throughout the several views, an exemplary embodiment of a matrix band retainer clip 32 is generally shown. As shown in FIG. 8, when it is in an installed condition, the exemplary retainer clip 32 is biased against the wings 30 of the matrix band 26 to seal the wings 30 against the decayed tooth 20. The seal is liquid tight, and therefore, the matrix band 26 is now able to maintain the liquid filling material in the bored out cavity 22 until the filling material finishes curing to a solid state. As discussed in further detail below, normal use of the exemplary retainer clip 32 during dental filling procedures does substantially no damage to the retainer clip 32, thereby providing it with a significantly longer life span than other known retaining clips which tend to degrade after each use. As also shown in FIG. 8 and discussed in further detail below, the exemplary retainer clip 32 also may hold a rubber dam 34 in a position below the decayed tooth 20 where the rubber dam 34 can catch debris or other contaminants from the filling operation. In other words, in addition to biasing the wings 30 of the sectional matrix band 26 against the decayed tooth 20, the exemplary retainer clip 32 doubles as a rubber dam clip.

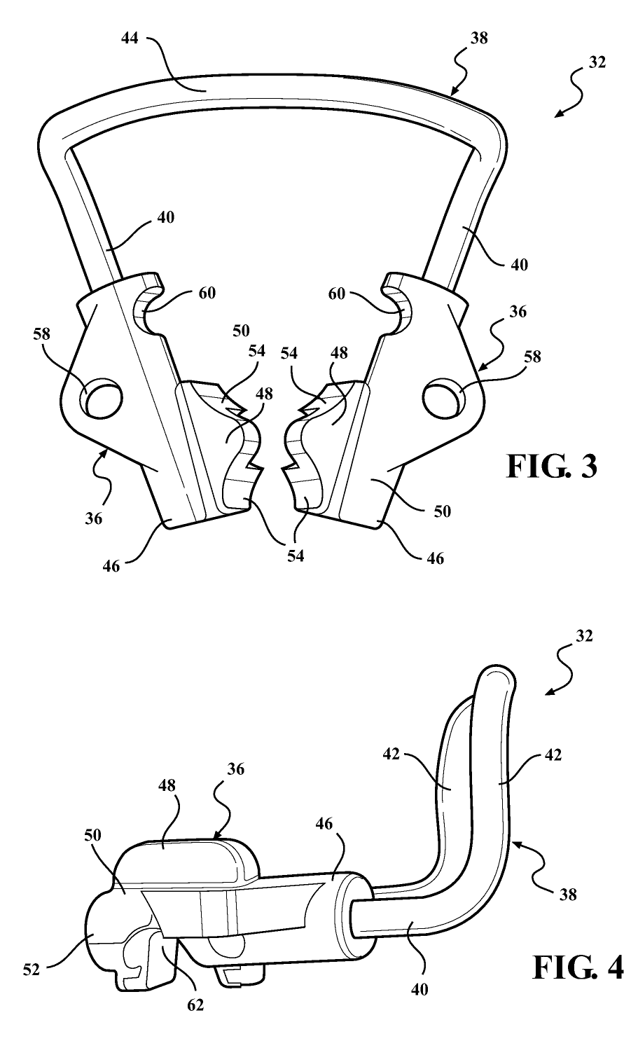

Referring now to FIG. 2, the matrix band retainer clip 32 of the exemplary embodiment includes a pair of tines 36 which are minor images of one another and are connected by a spring 38. In the exemplary embodiment, the spring 38 is of an elongated piece of a wire-like metal which is bent through a plurality of curves so that, as shown in FIG. 3, when the spring 38 is in a resting condition, the tines 36 are separated from one another by a gap which is less than the width of a tooth. In the exemplary embodiment, the spring 38 is formed of an elongated, stainless steel wire. However, it should be appreciated that the spring 38 could alternately be formed of a range of different elastically deflectable materials and could have a non-circular cross-section.

Referring back to FIG. 2, the spring 38 has a pair of diverging portions 40 which are in engagement with the tines 36 and diverge away from one another when the retainer clip 32 is in the resting condition. The spring 38 also includes a generally U-shaped portion which is joined with the diverging portions 40. The U-shaped portion has a pair of vertical legs 42 that extend in spaced and parallel relationship with one another and a single lateral leg 44 that extends generally transversely between the vertical legs 42. The lower ends of the vertical legs 42 are joined with the ends of the diverging portions 40 opposite of the tines 36. As will be discussed in further detail below, when the retainer clip 32 is in an installed condition, the lateral leg 44 extends vertically above a tooth from one side to the other. As shown in FIGS. 3 and 4 respectively, when the spring 38 is in the relaxed condition, it is generally triangularly shaped when viewed from the top and L-shaped when viewed from the side. As also shown in FIG. 3, the lateral leg 44 of the spring 38 has a slight curve or bend shape when in the resting condition. As discussed in further detail below, the curve assists in distributing stresses along the length of the spring 38 when the tines 36 are spread apart. The retainer clip 32 preferably has a length that is in the range of 10-45 mm, a width in the range of 8-35 mm and a height in the range of 6-25 mm.

Referring back to FIG. 2, each of the tines 36 has a generally cylindrical portion 46 which receives and engages a length of a diverging portion 40 of the spring 38. The tines 36 are preferably interconnected with the diverging portions 20 of the spring 38 through an overmolding process, i.e. the tines 36 are injection molded into engagement with a feature (not shown) on the diverging portions 40 of the spring 38. However, it should be appreciated that the tines 36 could be joined to the spring 38 through any suitable process. An inner edge of each tine 36 has a generally wedge-shaped piece 48 that is shaped to fit at least partially into an interproximal space between adjacent teeth. As shown, in the exemplary embodiment, the wedge-shaped pieces 48 extend vertically above and below the cylindrical portion 46, thus presenting upper and lower ledges 50, 52 on the top and bottom surfaces of the cylindrical portion 46 respectively. Each wedge-shaped piece 48 has a pair of contact surfaces 54 which are angled relative to one another for engaging against the sectional matrix band 26 and the adjacent tooth 24 during the dental filling operation. The tines 36 are preferably formed of a polymeric material but may be of any suitable material including, for example, various metals, ceramics or composites.

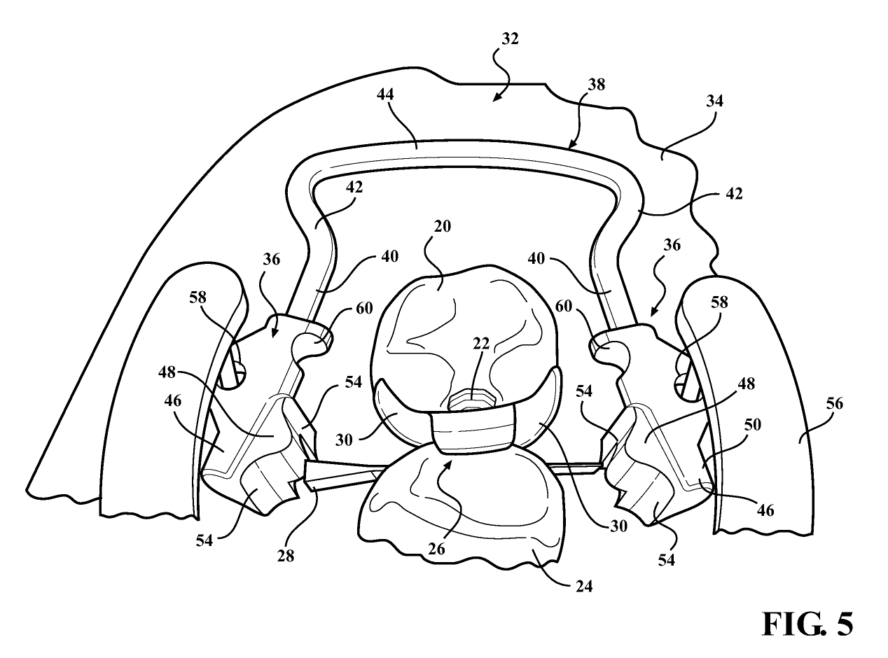

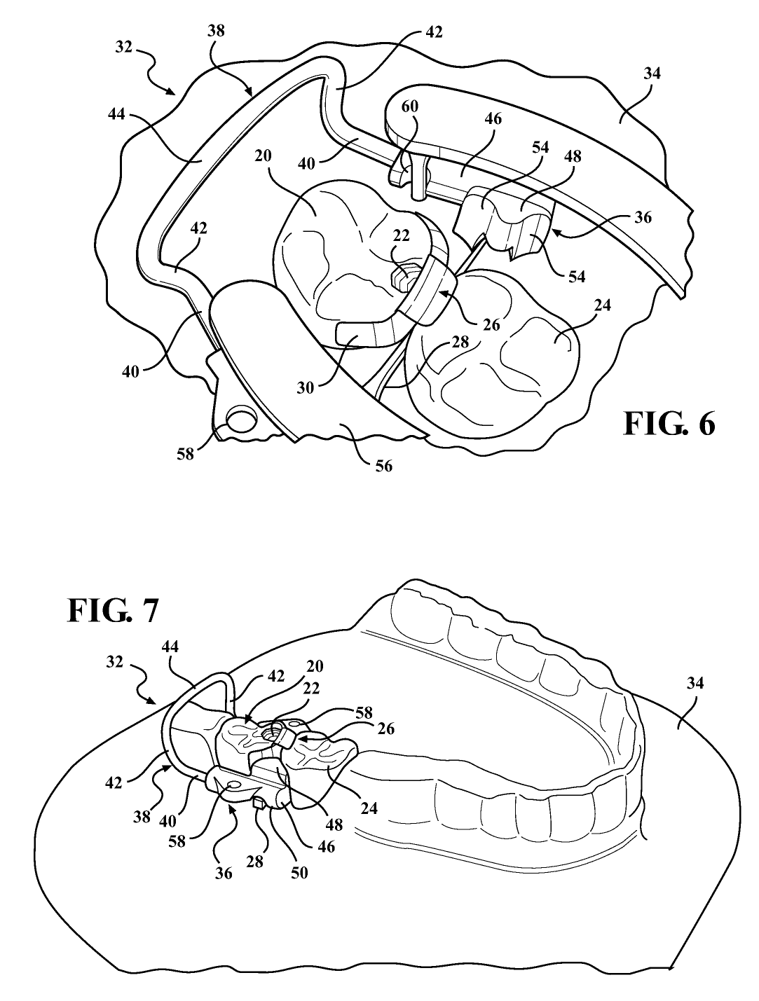

Referring still to FIG. 2, in the exemplary embodiment of the retainer clip 32, each tine 36 has two separate features which are configured to receive forceps 56 (such as those shown in FIGS. 5 and 6) or other tools to spread the tines 36 apart from one another for engaging the retainer clip 32 against a sectional matrix band 26 or disengaging the retainer clip 32 from the sectional matrix band 26. In other words, the forceps 56 (or other tools) engage the features for installation and removal of the exemplary retainer clip 32. One of the features is an aperture 58 which is disposed on the opposite side of the spring 38 from the wedge-shaped piece 48. In FIG. 5, a set of dental forceps 56 is shown engaging the apertures 58 and spreading the tines 36 apart from one another. Referring back to FIG. 2, the other feature is a notch 60 on an inner edge of each tine 36. In FIG. 6, the forceps 56 are shown engaging the notches 60 on the tines 36 and spreading the tines 36 apart from one another. A dentist or dental assistant may use whichever feature he or she feels more comfortable with to spread the tines 36 apart. However, it should be appreciated that the retainer clip 36 could have any suitable feature or features for spreading the tines 36.

Because of the shape of the spring 28, spreading the tines 36 apart is a very simple process which requires very little effort by a dentist or a dental assistant. Additionally, during normal use of the exemplary retainer clip 32, spreading the tines 36 apart does substantially no damage to the spring 38. For example, as best shown in FIG. 5, stresses from spreading the tines 36 apart are distributed along substantially the entire length of the spring 38 and there is no centralized stress point as is common on other known retainer springs. As such, all deformation of the spring 38 when the tines 36 are spread apart is elastic, thus ensuring that the retainer clip 32 always returns to substantially the same resting condition after each use. Because there is no plastic deformation, spreading the tines 36 does not result in work hardening of the base material of the spring 38. This allows for a substantially improved lifespan as compared to other known matrix retainer clips, whose springs tend to work harden and become increasingly brittle with each use. When the tines 36 of the exemplary embodiment are spread apart, the diverging portions 40 and the lateral leg 44 of the spring 38 experience a bending stress and the vertical legs 42 experience both a twisting and bending stresses.

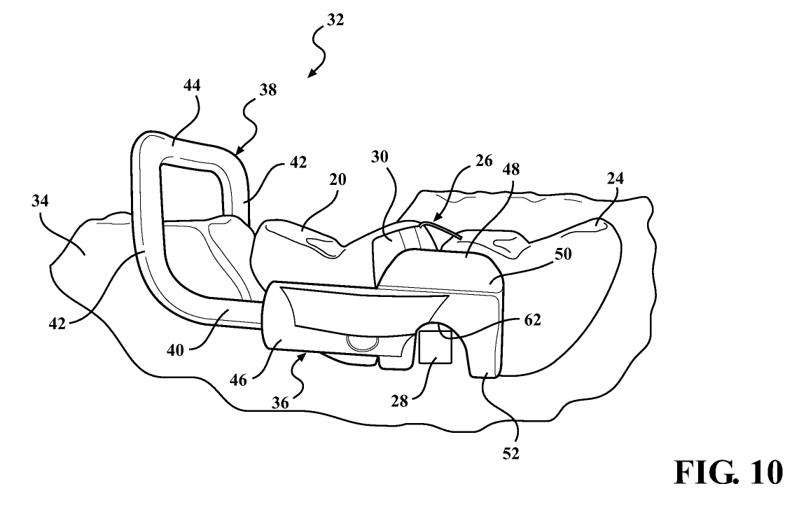

Referring now to FIG. 10, a lower area of each tine 36 includes a laterally extending groove 62 for partially encircling the wedge 28 between the matrix clip 26 and the adjacent tooth 24 during the dental filling operation. As shown, the groove 62 extends laterally through the middle of the wedge-shaped piece 48, which is aligned with the middle of the interproximal space between the decayed tooth 20 and the adjacent tooth 24.

Use of the retainer clip 32 is a very simple and quick process. First, the sectional matrix band 26 is put in place between the decayed tooth 20 and the adjacent tooth 24 as shown in FIG. 1. A wedge 28 may then be inserted between the sectional matrix band 26 and the adjacent tooth 24 to bias a lower portion of the sectional matrix band 26 against the decayed tooth 20. Next, with the sectional matrix band 26 and the wedge 28 in place, a user engages prongs on a set of forceps 56 into either the apertures 58 or the notches 60 on the tines 36, spreads the tines 36 apart, and releases the forceps 56 from the tines 36 so that the wedge 28 shaped pieces 48 project into the interproximal space between the sectional matrix band 26 and the adjacent tooth 24. As shown in FIG. 8, in this installed condition, the spring 38 biases one contact surface 54 of each of the wedge-shaped pieces 48 against a wing 30 on the sectional matrix band 26 to seal the wing 30 against the decayed tooth 20 and biases the other contact surface 54 against the adjacent tooth 24. Referring now to FIG. 9, in addition to being biased inwardly, the configuration of the spring 38 causes the tines 36 to also be biased in a vertically downward direction towards the gingival margin of a patient's mouth. This prevents accidental disengagements of the retainer clip 32 from the sectional matrix band 26 during the dental filling procedure. In other words, a stronger connection is established between the sectional matrix band 26 and the retainer clip 32 of the exemplary embodiment than is possible with other known retainer clips.

The retainer clip 32 of the exemplary embodiment may then be inserted through an opening in a rubber dam 34 and the rubber dam 34 may be sealed against the decayed tooth 20 and the adjacent tooth 24 for catching any debris from the dental filling operation. The rubber dam 34 is held vertically below the retainer clip 32 and out of the way of the dentist or dental assistant by the lower ledges 52 on the tines 36. For example, FIG. 8 shows a rubber dam 34 that is held in place by the retainer clip 32 of the exemplary embodiment. Since the retainer clip 32 of the exemplary embodiment holds the rubber dam 34 in place, a separate rubber dam clip is not required. In addition to cost savings, this provides for time savings because the dentist or dental assistant only has to use one clip, not two. A dentist or dental assistant may then inject the liquid filling material into the bored cavity 22 of the decayed tooth 20. The rubber dam 34, retainer clip 32, wedge 28 and sectional matrix band 26 are preferably left in place until the filling material cures to a solid state.

Referring now to FIG. 10, when the retainer clip 32 is in an installed position biased against a sectional matrix band 26, the tines 36 are substantially entirely below the top surface of the decayed tooth 20 and the diverging portions 40 of the spring 38 run along the gingival line. As such, only the lateral leg 44 and portions of the vertical legs 42 are disposed vertically above the top surface of the decayed tooth 20. However, as shown in FIG. 8, the lateral leg 44 and the vertical legs 42 of the spring 38 are spaced longitudinally from the decayed tooth 20. This unique configuration provides the dentist or dental assistant with easy access to the bored cavity 22 of the decayed tooth 20 to make the filling process itself easier than when other known retaining clips are employed.

Obviously, many modifications and variations of the present invention are possible in light of the above teachings and may be practiced otherwise than as specifically described while within the scope of the appended claims.

What is claimed is:

1. A matrix band retainer clip for sealing a matrix band against a tooth, comprising:
a pair of tines;
each of said tines having a generally wedge-shaped piece with a pair of contact surfaces that are angled relative to one another;
a spring coupled with and extending between said tines and biasing said tines towards one another to apply a biasing force from at least one contact surface of each tine against the matrix band thereby sealing the matrix band against the tooth; and
said spring having a generally U-shaped portion with a pair of vertically extending legs coupled with said tines at their lower ends and interconnected with one another at their upper ends by a generally laterally extending leg for distributing a stress across a length of said spring in response to said tines being separated from one another.

2. The matrix band retainer clip as set forth in claim 1 wherein said generally U-shaped portion of said spring is spaced longitudinally from said tines.

3. The matrix band retainer clip as set forth in claim 1 wherein said spring is a wire that is bent.

4. The matrix band retainer clip as set forth in claim 3 wherein said wire is of stainless steel.

5. The matrix band retainer clip as set forth in claim 1 wherein said spring includes a pair of diverging portions which are coupled with said tines and diverge from one another while extending to said generally U-shaped portion.

6. The matrix band retainer clip as set forth in claim 5 wherein said tines are in engagement with said diverging portions of said spring through an overmolding connection.

7. The matrix band retainer clip as set forth in claim 1 wherein said tines have lower ledges which are configured to engage a rubber dam and hold the rubber dam below the tooth.

8. The matrix band retainer clip as set forth in claim 1 wherein each of said tines has an aperture for receiving a prong on a set of forceps.

9. The matrix band retainer clip as set forth in claim 1 wherein each of said tines has an inner edge with a notch for receiving a prong on a set of forceps.

10. The matrix band retainer clip as set forth in claim 1 wherein said tines are generally minor images of one another.

11. The matrix band retainer clip as set forth in claim 1 wherein each of said tines has a laterally extending groove for receiving a wedge.

12. A method of repairing a tooth having a cavity, comprising the steps of:
preparing a matrix band retainer clip that has a pair of tines and a spring with a generally U-shaped portion that has a pair of vertically extending legs interconnected with one another by a laterally extending leg;
inserting a sectional matrix band between the tooth and an adjacent tooth;
spreading the tines of the matrix band retainer clip from one another with a set of forceps;
releasing the matrix band retainer clip from the forceps to engage the matrix band clip with the matrix band;
biasing the matrix band retainer clip against the matrix band with the spring to seal the matrix band against the tooth;
filling the cavity with a filling material; and
curing the filling material.

13. The method as set forth in claim 10 further including the step of inserting the matrix band retainer clip into an open of a rubber dam and engaging the rubber dam against the matrix band retainer clip.

14. The method as set forth in claim 10 further including the step of inserting a wedge between the sectional matrix band and the adjacent tooth before the step of spreading the tines of the matrix band clip.
